(19) United States
(12) Patent Application Publication
(10) Pub. No.: US 2022/0366557 A1
(43) Pub. Date: Nov. 17, 2022

(54) IMAGE PROCESSING APPARATUS, IMAGE PROCESSING METHOD, AND RECORDING MEDIUM

(71) Applicant: CANON KABUSHIKI KAISHA, Tokyo (JP)

(72) Inventor: Tomoe Kikuchi, Tokyo (JP)

(21) Appl. No.: 17/737,429

(22) Filed: May 5, 2022

(30) Foreign Application Priority Data
May 12, 2021 (JP) 2021-081092

(51) Int. Cl. G06T 7/00

(52) U.S. Cl. CPC G06T 7/0004; G06T 2207/30144

(57) ABSTRACT

An image processing apparatus includes an acquisition unit configured to acquire a plurality of image data read from a plurality of areas of a print product, and an evaluation unit configured to obtain degrees of streaks in the plurality of areas and tilts in the plurality of areas using the plurality of image data and evaluate image quality of the print product based on the degrees and the tilts.

### BACKGROUND

### Field of the Disclosure

The present disclosure relates to a technique for evaluating image quality of print products.

### Description of the Related Art

There are cases where print products of an image forming apparatus, such as a copy machine, include streaky noise (which will be referred to as streaky unevenness). This streaky unevenness is considered as an issue in terms of image quality. Thus, various techniques for evaluating this streaky unevenness have been proposed.

Japanese Patent Application Laid-Open No. 2007-280273 discusses performing averaging in an area, for which an evaluation value is to be calculated, in a one-dimensional direction, creating one-dimensional profile information about brightness, and calculating an evaluation value using frequency characteristics of this profile. If an evaluation target image is tilted at the time of printing or reading (scanning), since a corresponding streak is defocused when the averaging is performed in the one-dimensional direction, an accurate evaluation value is not calculated.

However, it is difficult to perform printing or scanning while maintaining a scan direction and the streaky unevenness in parallel to each other.

Meanwhile, there is a technique that does not calculate an evaluation value for each print product. In this technique, a print product including a dense streak is determined from among a plurality of print products output by an image forming apparatus. Then, a weight is given to the evaluation value of the determined print product. This weighted evaluation value is used as a comprehensive evaluation value of the image forming apparatus.

### SUMMARY

According to embodiments of the present disclosure, an image processing apparatus includes an acquisition unit configured to acquire a plurality of image data read from a plurality of areas of a print product, and an evaluation unit configured to obtain degrees of streaks in the plurality of areas and tilts in the plurality of areas using the plurality of image data and evaluate image quality of the print product based on the degrees and the tilts.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of a computer system.

FIG. 2 is a flowchart illustrating calculation of a comprehensive evaluation value according to a first exemplary embodiment.

FIG. 3 is a flowchart illustrating calculation of a tilt and an evaluation value of an evaluation image according to the first exemplary embodiment.

FIG. 4 illustrates an example of an evaluation value of an individual image according to the first exemplary embodiment.

FIG. 5 is a flowchart illustrating calculation of a comprehensive evaluation value according to a second exemplary embodiment.

FIG. 6 is a flowchart illustrating calculation of a tilt and an evaluation value of an evaluation image according to the second exemplary embodiment.

FIG. 7 is a flowchart illustrating calculation of a comprehensive evaluation value according to a third exemplary embodiment.

FIG. 8 is a flowchart illustrating calculation of a comprehensive evaluation value according to a fourth exemplary embodiment.

### DESCRIPTION OF THE EMBODIMENTS

Even if tilts of a plurality of images used for calculating evaluation values are within an allowable angle, it is difficult to set the tilts to the same angle. Even if individual evaluation values calculated from the plurality of images indicate errors within an allowable range, the different tilts of the individual images affect the order of the evaluation values. Thus, there are cases where appropriate evaluation values cannot be calculated about the streaky unevenness.

Hereinafter, exemplary embodiments of the present disclosure will be described with reference to the accompanying drawings. The following exemplary embodiments do not limit the present disclosure, and all combinations of features described in the exemplary embodiments are not essential for the solution of the present disclosure. The same components will be denoted by the same reference numerals. In addition, each step in each flowchart will be denoted by a reference numeral starting with S.

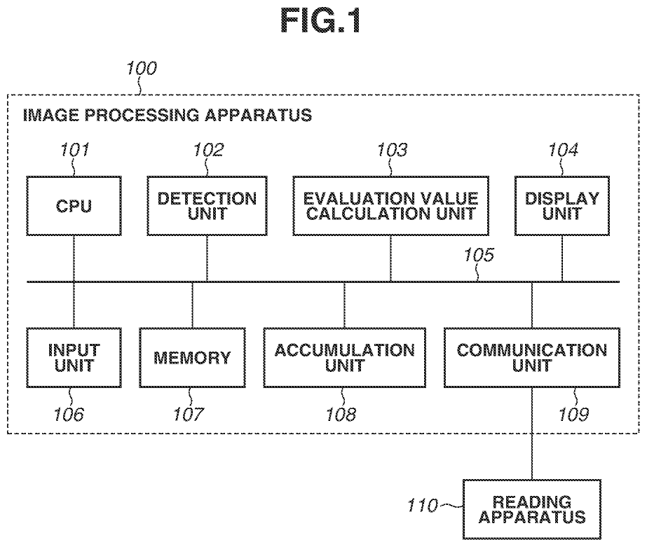

FIG. 1 is a block diagram of an image processing apparatus 100 according to a first exemplary embodiment. A central processing unit (CPU) 101 controls various units by executing commands according to various programs stored in a memory 107, to perform various kinds of processing. An input unit 106 receives, for example, instructions from a user and instructions for acquiring scanned images from a reading apparatus 110. The input unit 106 includes, for example, a pointing system such as a keyboard or a mouse. A detection unit 102 determines and detects a predetermined evaluation value calculation area (which will also be referred to as a calculation area) from image data.

An evaluation value calculation unit 103 calculates a quantitative evaluation value of streaky unevenness from an area detected by the detection unit 102. In a case where there are a plurality of areas, the evaluation value calculation unit 103 calculates an evaluation value for each of the areas. The memory 107 includes a read-only memory (ROM) and a random-access memory (RAM) and provides the CPU 101 with programs, data, work areas, etc. that are necessary for various kinds of processing. A display unit 104 is a liquid crystal display (LCD), for example.

An accumulation unit 108 is for accumulating image data, programs, etc. and is a hard disk, for example. The present exemplary embodiment assumes that a control program necessary for processing described in flowcharts to be described below is stored in the accumulation unit 108 or in the ROM in the memory 107. In a case where the control program is stored in the accumulation unit 108, the control program is first loaded to the RAM in the memory 107 and is next executed by the CPU 101.

The image processing apparatus 100 exchanges data with another apparatus via a communication unit 109. Each of the above units is connected to a bus 105 and exchanges data via the bus 105. The reading apparatus 110 is, for example, an image scanner and reads and acquires a print product, which is a document including characters or photographs, as digital data to transfer the acquired print product to the image processing apparatus 100 via the communication unit 109. If there are a plurality of print products, the reading apparatus 110 individually transfers the print products.

The system configuration can include components other than the above units.

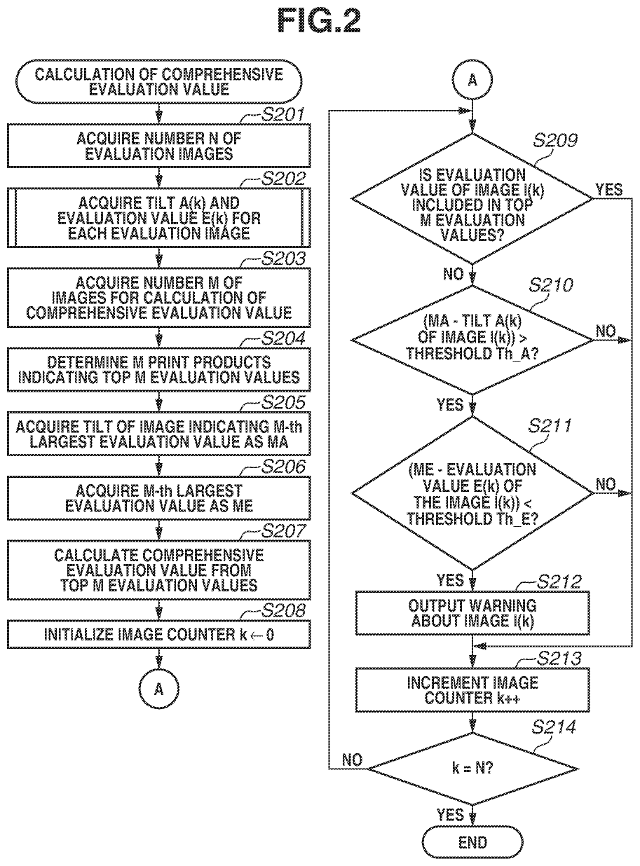

FIG. 2 illustrates a method in which, for the calculation areas detected by the detection unit 102, the evaluation value calculation unit 103 calculates a comprehensive streaky unevenness evaluation value (which will also be referred to as a comprehensive evaluation value) from streaky unevenness evaluation values (which will also be referred to as evaluation values), each of which is an image quality evaluation value indicating the degree of a streak. While the degree of a streak is the density of the streak in the present exemplary embodiment, the degree of a streak can be presence or absence of a streak. In the present exemplary embodiment, three images including stronger streaky noise are determined from 10 images, and an average value of the evaluation values of the three images will be used as a comprehensive evaluation value.

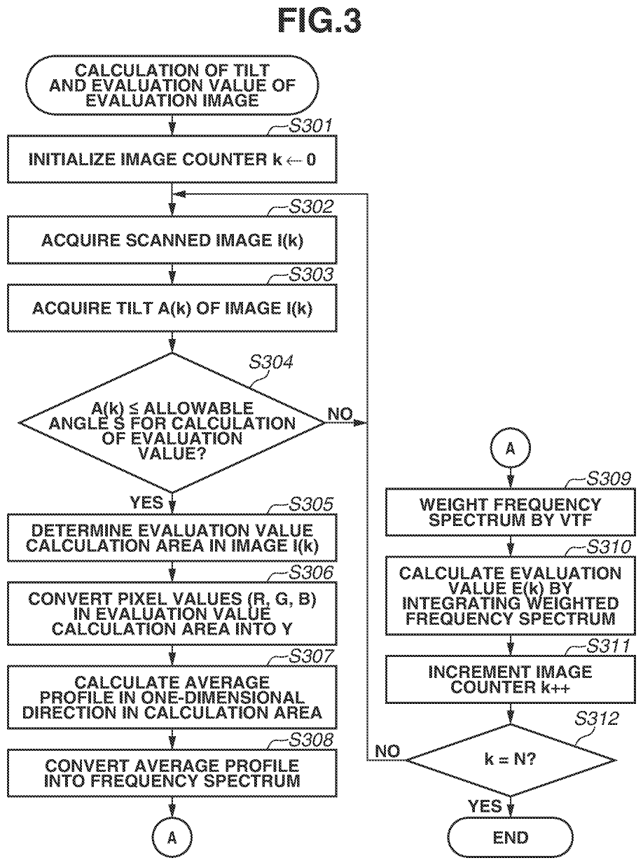

In step S201, a number N of evaluation images used for comprehensive evaluation is acquired. In the present exemplary embodiment, N=10. In step S202, a tilt A(k) and an evaluation value E(k) (k=0, 1, . . . , 9) are acquired for each of the N evaluation images. A larger evaluation value E(k) is calculated for a denser streak, that is, for more apparent streaky noise. Step S202 will be described with reference to FIG. 3.

In step S301, an image counter k is initialized to zero.

In step S302, the reading apparatus 110 scans the k-th print product, and the image processing apparatus 100 acquires image data of a scanned image I(k) (this image data will also be referred to as an image).

In step S303, a tilt A(k) of the scanned image I(k) is calculated. Regarding the calculation of the tilt A(k), in a case where the image has a tilt detection marker, an angle made by a line calculated from the marker and an individual image end can be calculated. Alternatively, a rectangular area provided on the image at a normal location can be detected, and an angle formed by an outer frame of the rectangular area and an individual image end can be calculated. In addition, while a tilt could be recognized both in a positive direction and a negative direction, since an absolute value of the tilt affects the corresponding evaluation value, the absolute value of the tilt A(k) is used in this step S303.

In step S304, whether the tilt A(k) of the scanned image I(k) acquired in step S303 is less than or equal to an allowable angle S for calculation of an evaluation value is determined. The present exemplary embodiment assumes that the allowable angle S is a predetermined angle, e.g., 0.2 degrees. In a case where the tilt A(k) is less than or equal to the allowable angle S for calculation of the evaluation value (YES in step S304), the processing proceeds to step S305. Otherwise, the scanning operation itself needs to be performed again. Thus, the processing returns to step S302, and the k-th print product is scanned again.

In step S305, a calculation area in the image I(k) is determined. This calculation area can be an area determined in advance by a relative value based on a tilt detection marker or can be acquired from an input by the user about the image I(k) via the input unit 106.

In step S306, pixel values (R, G, B) in the calculation area are converted into luminance values Y. There are various equations for converting pixel values into luminance values Y. In the present exemplary embodiment, each set of pixel values is converted into a luminance value Y in accordance with an equation Y=0.2126R+0.7152G+0.0722B.

In step S307, the luminance values Y in the calculation area determined in step S305 are averaged in a one-dimensional direction so that an average profile is calculated. Thus, if the calculation area is represented by W×H [pixels], an average profile of W×l [pixels] is calculated.

In step S308, Fourier transform is performed on the average profile acquired in step S307 such that the average profile is converted into a frequency spectrum.

In step S309, the frequency spectrum is multiplied and weighted by human visual characteristics (a visual transfer function (VTF)). While examples of the visual characteristics include an equation by Dooley, the present exemplary embodiment is not limited to this example.

In step S310, by integrating the VTF-weighted frequency spectrum acquired in step S309, an evaluation value E(k) representing the density of the streak of the image I(k) is obtained. The value obtained by integrating the frequency spectrum obtained in step S308 can be used as the evaluation value E(k).

In step S311, the image counter k is incremented by 1.

In step S312, the image counter k is compared with the number N of evaluation images acquired in step S201. In a case where the image counter k matches the number N of evaluation images (YES in step S312), the evaluation value calculation unit 103 determines that a tilt and an evaluation value have been calculated for each evaluation image and ends the processing in FIG. 3. That is, the processing proceeds to step S203 in FIG. 2. In a case where the image counter k does not match the number N of evaluation images (NO in step S312), the processing returns to step S302, and a tilt and an evaluation value are calculated for the next image.

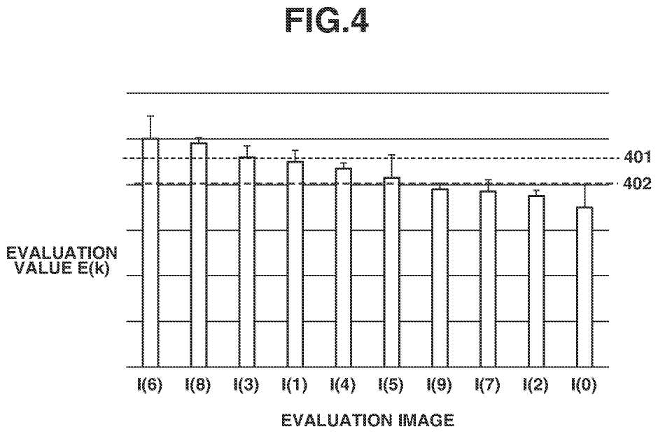

In the present exemplary embodiment, the evaluation values E(k) calculated for the images I(0) to I(9) are arranged in descending order, and a bar graph is created as illustrated in FIG. 4. A thin line extending from the top of the individual bar in FIG. 4 represents a predicted error range of the evaluation value based on the tilt A(k). In other words, the thin lines in the bar graph represent the tilts A(k) of the respective images.

For ease of description, the present exemplary embodiment assumes three kinds of predicted error ranges based on the tilts illustrated in FIG. 4. That is, the images I(6), I(5), and I(0) each have the largest predicted error range, that is, the largest tilt. The images I(3), I(1), and I(7) each have the second largest predicted error range, that is, the second largest tilt. Lastly, the images I(8), I(4), I(9), and I(2) each have the smallest predicted error range, that is, the smallest tilt.

In step S203, a number M of images used for calculation of a comprehensive evaluation value is acquired. In the present exemplary embodiment, M=3.

In step S204. M print products indicating the top M evaluation values are determined. In the present exemplary embodiment, as illustrated in FIG. 4, the images I(6), I(8), and I(3) are determined as the top M (M=3) images. A horizontal dashed line 401 in FIG. 4 represents the M-th largest evaluation value.

In step S205, the tilt of the image indicating the M-th largest evaluation value is acquired as MA. In the present exemplary embodiment, MA=A(3).

In step S206, the smallest one of the M evaluation values of the images determined in step S204, that is, the M-th largest evaluation value, which is determined when the evaluation values are arranged in descending order, is acquired as ME. In the present exemplary embodiment, E(3) is acquired.

In step S207, a comprehensive evaluation value is calculated from the evaluation values E of the M print products determined in step S204. In the present exemplary embodiment, (E(3)+E(6)+E(8))/3 is calculated as the comprehensive evaluation value.

Among the images other than the top M images, there may be an image that has not been selected as one of the top M images probably because of its relatively small evaluation value due to its tilt. In step S208 and the subsequent steps thereof, whether an image having a tilt is reliable, that is, whether an image can be used for calculation of a comprehensive evaluation value, is determined. In a case where there is an image that is not reliable, the user is notified of a warning indicating that this image is not suitable for calculation of an evaluation value. This notification is achieved by outputting the above warning to the display unit 104, for example.

In step S208, the image counter k is initialized to zero.

In step S209, whether the image I(k) is included in the M print products determined in step S204 is determined. In a case where the image I(k) is not included (NO in step S209), the processing proceeds to step S210. In a case where the image I(k) is included (YES in step S209), the processing proceeds to step S213. In the present exemplary embodiment, in a case where k=3, 6, or 8, the processing proceeds to step S213. Otherwise, the processing proceeds to step S210.

In step S210, whether the difference between the tilt A(k) of the image I(k) and the tilt MA acquired in step S205 exceeds a predetermined threshold Th_A (>0) is determined. In a case where the difference exceeds the threshold Th_A (YES in step S210), the processing proceeds to step S211. Otherwise (NO in step S210), the processing proceeds to step S213. In the present exemplary embodiment, since the images I(1) and I(7) have approximately the same tilt as that of the image I(3), the difference between the tilt A(1) and the tilt A(3) and the difference between the tilt A(7) and the tilt A(3) are each less than the threshold Th_A. If the tilt A(3) is subtracted from the tilt of the images I(8), I(4), I(9), and I(2), in which the tilt is the smallest tilt, a negative value is obtained so that the difference is less than the threshold Th_A. If the tilt A(3) is subtracted from the tilt of the images I(6), I(5), and I(0), in which the tilt is the largest tilt, the difference exceeds the threshold Th_A. That is, if k=0, 5, or 6, the processing proceeds to step S211. Otherwise, the processing proceeds to step S213.

In step S211, the evaluation value E(k) of the image I(k) is subtracted from the evaluation value ME acquired in step S206, and the difference is compared with a predetermined threshold Th_E. In a case where the difference is less than the threshold Th_E (YES in step S211), that is, if the image I(k) has a relatively large tilt, the processing proceeds to step S212. Otherwise (NO in step S211), the processing proceeds to step S213.

In other words, in a case where the difference between the evaluation values is less than the threshold Th_E, the evaluation value E(k) calculated again after the tilt of the image I(k) is modified could become larger than the evaluation value ME. In the present exemplary embodiment, the evaluation value E(3), which is the M-th (3rd)largest from the top, is ME, and a value obtained by subtracting the threshold Th_E from the evaluation value ME is a value indicated by a dashed line 402 in FIG. 4. While the images I(0), (5), and (6) are the determination targets in step S211, the evaluation value of the image I(5) falls between the dashed lines 401 and 402.

In step S212, a warning is output about the image I(k), and the processing proceeds to step S213. The warning notifies the user that the image I(k) is not reliable in terms of calculation of an evaluation value.

In step S213, the image number is incremented by adding 1 to the image counter k. In step S214, the image counter k is compared with the number N of evaluation images acquired in step S201. In a case where the image counter k matches the number N of evaluation images (YES in step S214), it is determined that all evaluation images have been processed, and the present processing ends. Otherwise, the processing returns to step S209, and the next image is processed.

In the present exemplary embodiment, the difference between the evaluation value ME and each of the evaluation values of the three images I(1), I(4), and I(5) is less than Th_E. The image I(4) has a tilt smaller than that of the image I(3), that is, the predicted error range is narrow. Thus, even if the maximum predicted error is estimated, the evaluation value will not exceed the evaluation value E(3). Even if the tilt of the image I(4) is reduced, it is less likely that the order of the image I(3) and the image I(4) will be switched. Thus, a warning is not output. If the maximum predicted error of the image I(1) is estimated, the evaluation value of the image I(1) becomes larger than the evaluation value E(3). However, the image I(0) has approximately the same tilt as that of the image I(3). That is, both of the images have approximately the same evaluation value error. Thus, even if the tilt of the image is reduced, since it is less likely that the order of the images I(1) and I(3) will be switched finally, a warning is not output.

According to the present exemplary embodiment, whether the order necessary for calculating a comprehensive evaluation value has been obtained can be determined. In addition, if there is an image that could affect the order, this image can easily be determined.

In the first exemplary embodiment, the evaluation value is calculated by weighting a one-dimensional profile by a predetermined VTF. However, there are various kinds of streaky noise, including thin streaks and thick streaks. Depending on the purpose of use of the print product, the streaks to be evaluated differ. For example, in the case of print products, such as magazines, which people browse with their hands, it is appropriate to evaluate thin streaks formed by high frequencies. However, in the case of print products, such as posters, which are viewed from the distance, it is appropriate to evaluate streaks formed by low frequencies, rather than the thin streaks formed by high frequencies.

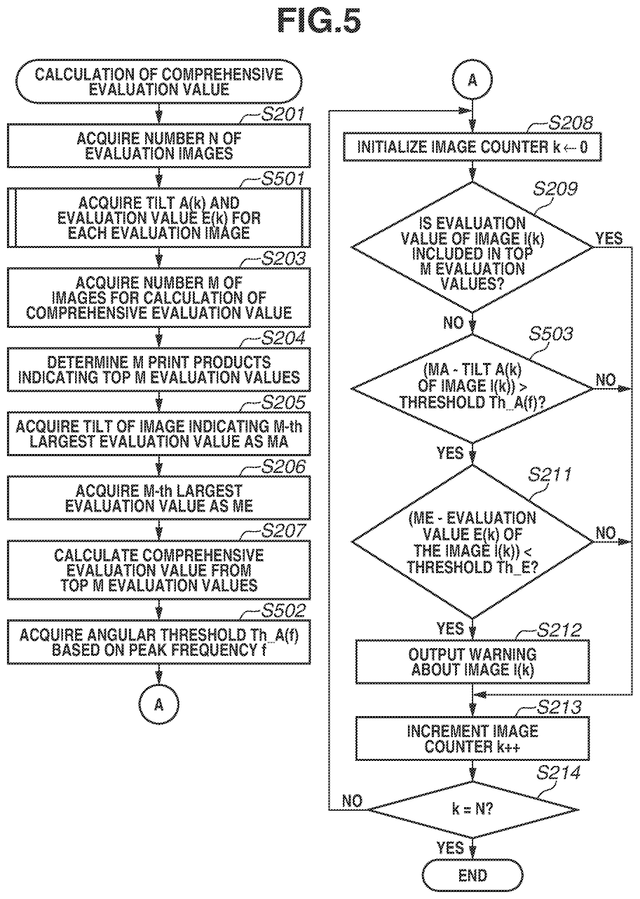

Since the impact of the streaky unevenness formed by low frequencies is reduced by a tilt at the time of scanning, there is no need to use the same thresholds. Then, a method according to a second exemplary embodiment will be described with reference to FIG. 5. In this method, an angular threshold is changed depending on the frequency of an evaluation target streak. In the following flowcharts according the second exemplary embodiment, the steps corresponding to the same operations as those according to the first exemplary embodiment will be denoted by the same reference numerals, and detailed description thereof will be omitted.

In step S201, a number N of evaluation images used for calculation of a comprehensive evaluation value is acquired.

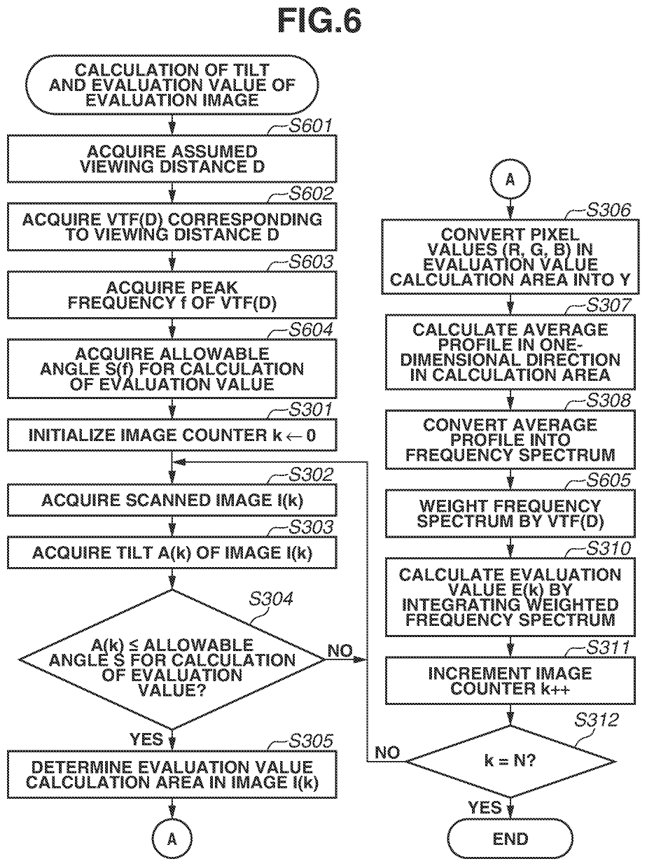

In step S501, a tilt A(k) and an evaluation value E(k) are acquired for each evaluation image. In the present exemplary embodiment, unlike the first exemplary embodiment, the frequency of the target streak can be changed, and an evaluation value can be calculated accordingly. The processing for calculating the evaluation value will be described with reference to FIG. 6. In the flowchart in FIG. 6, the steps corresponding to the same operations as those according to the first exemplary embodiment will be denoted by the same reference numerals in FIG. 3, and detailed description thereof will be omitted.

In step S601, an assumed viewing distance D used when the evaluation is performed is acquired. That is, an evaluation value in which the distance to the evaluation target print product when the print product is visually evaluated is assumed can be specified. If the viewing distance D is long, thin high-frequency streaks are not easily recognized. If the viewing distance D is short, thin high-frequency streaks are easily recognized. In other words, the assumed viewing distance D is a parameter highly correlated with the frequency of the evaluation target streak.

In step S602, human visual characteristics VTF(D) corresponding to the assumed viewing distance D are acquired. As in the first exemplary embodiment, if an equation by Dooley is used as the visual characteristics, the parameter of the observation distance in the equation is changed. However, the present exemplary embodiment is not limited to this example.

In step S603, a peak frequency f of the visual characteristics VTF(D) acquired in step S602 is acquired.

That is, the frequency of the evaluation target streak is acquired.

In step S604, an allowable angle S(f) used for calculation of an evaluation value for the streak having the frequency acquired in step S603 is acquired. The lower the frequency is, a larger value is acquired as the allowable angle S(f). Then, the processing proceeds to step S301. Steps S301 to S308 are the same as those according to the first exemplary embodiment, and detailed description thereof will be omitted.

In step S605, the frequency spectrum obtained in step S308 is multiplied and weighted by the visual characteristics VTF(D) acquired in step S602. In step S310, the weighted frequency spectrum obtained in step S605 is integrated to calculate an evaluation value E(k). That is, step S605 reduces the spectrum of the frequency not easily perceived, based on the assumed viewing distance D. As a result, the impact on the evaluation value E(k) can be reduced.

Steps S311 and S312 are the same as those according to the first exemplary embodiment.

Upon completing the present flowchart, the processing proceeds to step S203 in FIG. 5. Steps S203 to S207 are the same as those according to the first exemplary embodiment.

In step S502, a predetermined angular threshold Th_A(f) based on the peak frequency f acquired in step S603 is acquired. Steps S208 and S209 are the same as those according to the first exemplary embodiment. In step S503, whether the difference between the tilt A(k) of the image I(k) and the tilt MA acquired in step S205 exceeds the predetermined threshold Th_A(f) (>0) is determined. In a case where the difference exceeds the threshold Th_A(f) (YES in step S503), the processing proceeds to step S211. Otherwise, the processing proceeds to step S213. Steps S211 to S214 are the same as those according to the first exemplary embodiment, and description thereof will be omitted.

According to the present exemplary embodiment, an image for which a warning is to be output is determined in view of the frequency of the evaluation target streak.

In addition, in the present exemplary embodiment, the frequency of the evaluation target streak is determined based on the assumed viewing distance D, and the threshold Th_A is changed accordingly. However, the frequency of the evaluation target streak also differs depending on the assumed viewing distance, the size of the assumed evaluation target area, or the assumed viewing angle. Thus, the frequency of the evaluation target streak can be determined from these values, and the threshold Th_A can be changed accordingly. In this way, too, the same advantageous effects can be obtained.

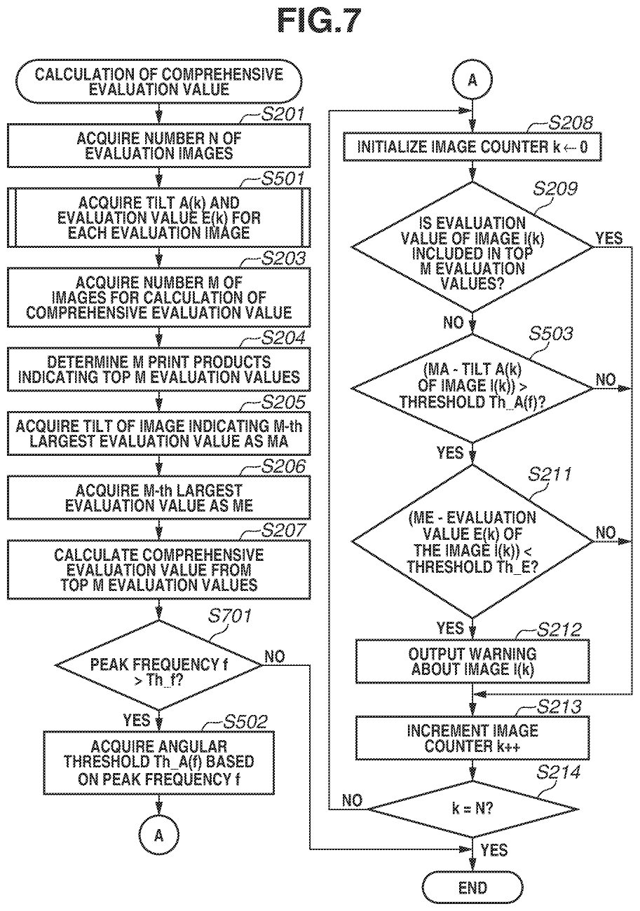

In the second exemplary embodiment, a threshold is changed depending on the frequency of the evaluation target streak. However, a streak of a predetermined frequency or less little affects calculation of an evaluation value. Thus, the determination of whether to output a warning does not need to be performed on such an image. A third exemplary embodiment describes a method in which whether to perform warning output determination is determined first. FIG. 7 illustrates the processing according to the present exemplary embodiment. In FIG. 7, the steps corresponding to the same operations as those according to the first or second exemplary embodiment will be denoted by the same reference numerals as those in FIGS. 2 and 5, and detailed description thereof will be omitted.

Steps S201, S501 and S203 to S207 in FIG. 7 are the same as those according to the second exemplary embodiment.

In step S701, whether the peak frequency f acquired in step S603 is larger than a frequency threshold Th_f is determined. The frequency threshold Th_f can be set in advance based on an experiment, for example. Step S502 and the subsequent steps thereof are the same as those according to the second exemplary embodiment.

In the first to third exemplary embodiments, the M images having larger streak evaluation values are acquired from the N evaluation images, and then a comprehensive evaluation value is calculated from the M streak evaluation values. However, a number or a ratio of images having an evaluation value more than or equal to a predetermined threshold can be used, instead of using a number or a ratio as the top M images. The present exemplary embodiment describes a method in which any number of images, each of which has a predetermined evaluation value B or more, is determined, and then a comprehensive evaluation value is calculated from these images.

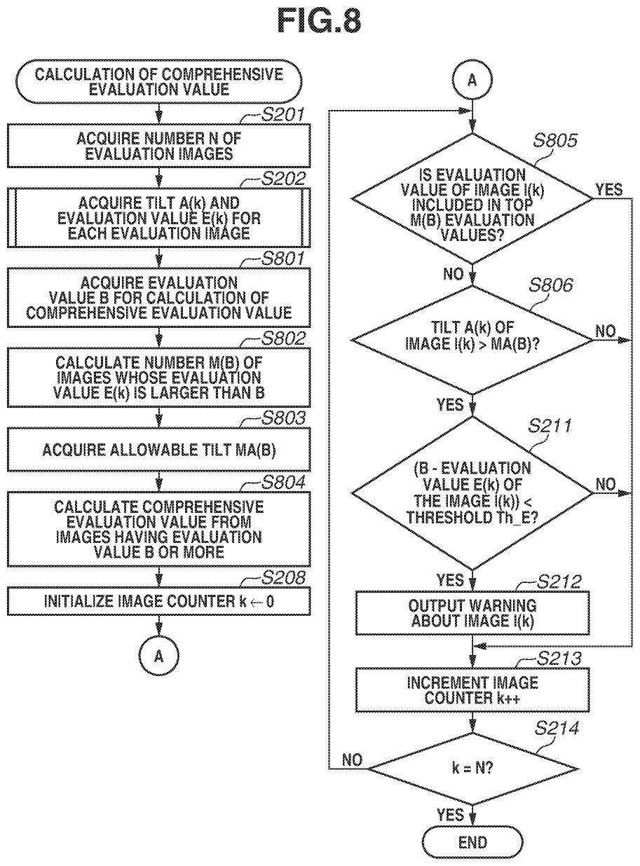

FIG. 8 illustrates a flowchart according to a fourth exemplary embodiment. In FIG. 8, the steps corresponding to the same operations as those according to the first exemplary embodiment will be denoted by the same reference numerals as those in FIG. 2, and detailed description thereof will be omitted.

Steps S201 and S202 are the same as those according to the first exemplary embodiment. In step S801, a predetermined evaluation value B for calculation of a comprehensive evaluation value is acquired. In step S802, images whose evaluation value E(k) is larger than the evaluation value B acquired in step S801 are determined, and a number M(B) of these images is acquired. In step S803, a predetermined allowable tilt MA is acquired. In step S804, a comprehensive evaluation value is calculated from the images having the evaluation value B or more. In the present exemplary embodiment, a ratio of images having the evaluation value B or more, that is, M(B)/N, is determined as a comprehensive evaluation value. In step S208, the image counter k is initialized to zero. In step S805, whether the image I(k) is included in the top M(B) images is determined. In a case where the image I(k) is included in the top M(B) images (YES in step S805), that is, in a case where the image I(k) is an image to be used for calculation of a comprehensive evaluation value, the processing proceeds to step S213. In a case where the image I(k) is not included in the top M(B) images (NO in step S805), that is, if the image I(k) is an image not to be used for calculation of a comprehensive evaluation value, the processing proceeds to step S806. In step S806, the allowable tilt MA(B) acquired in step S803 is compared with the tilt A(k) of the image I(k). In a case where the tilt A(k) is larger than the allowable tilt MA(B) (YES in step S806), the processing proceeds to step S211. Otherwise (NO in step S806), the processing proceeds to step S213. Steps S211 to S214 are the same as those according to the first exemplary embodiment.

According to the present exemplary embodiment, the images that could be used for calculation of a comprehensive evaluation value can easily be determined.

In addition, in the present exemplary embodiment, a streak of a fixed frequency is evaluated as in the first exemplary embodiment. However, as in the second or third exemplary embodiment, the frequency of the evaluation target streak can be changed. In this case, the allowable tilt MA(B) can be changed based on the frequency.

The first to third exemplary embodiments have described a method in which a comprehensive evaluation value is calculated by using an average value of the top M evaluation values. However, the above exemplary embodiments are not limited to this method. A method in which the M values are weighted and added or a method in which a median of the M values is used can alternatively be used.

The first to fourth exemplary embodiments have been described assuming that a single evaluation value is obtained from a single evaluation image. However, alternatively, evaluation values can be calculated from a plurality of areas on a single evaluation image, and a comprehensive evaluation value can be calculated from the evaluation values. In this case, paper could be diagonally fed at the time of printing or paper could unevenly expand and contract in vertical and horizontal directions by ink, and accordingly, different tilts could occur in evaluation areas in a single image.

Thus, the images in the first to fourth exemplary embodiments can be read as areas, and whether to output a warning can be determined per area.

In addition, in the second to fourth exemplary embodiments, while the frequency of the target streak, that is, the frequency used for calculation of a comprehensive evaluation value, is changeable, one kind of frequency is used. However, streaks of a plurality of kinds of frequencies can be used for single comprehensive evaluation value calculation processing. In other words, from a single print product, both a comprehensive evaluation value for a thin streak and a comprehensive evaluation value for a thick streak can be calculated. In this case, too, the tilt threshold Th_A(f) for determining whether to output a warning is calculated from each of the frequencies corresponding to the thin and thick streaks for which evaluation values are calculated. Thus, there are cases where a warning could be output only for the thin streak in the same image. A comprehensive evaluation value can be calculated from the comprehensive evaluation value corresponding to the thin streak and the comprehensive evaluation value corresponding to the thick streak.

Even in a case where an evaluation area is printed on both sides of a single image, it is needless to say that the present technique enables the determination of whether to output a warning.

As described above, the present technique can determine an image or area that could change a comprehensive evaluation value calculated from a plurality of images and can output a warning about the image or area. Accordingly, determination of whether to recalculate a comprehensive evaluation and determination of an image for which the recalculation needs to be performed can be easily performed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-081092, filed May 12, 2021, which is hereby incorporated by reference herein in its entirety.

What is claimed is:

1. An image processing apparatus comprising:
an acquisition unit configured to acquire a plurality of image data read from a plurality of areas of a print product; and
an evaluation unit configured to obtain degrees of streaks in the plurality of areas and tilts in the plurality of areas using the plurality of image data and evaluate image quality of the print product based on the degrees and the tilts.

2. The image processing apparatus according to claim 1, wherein each of the degrees is a value representing a density or presence or absence of one of the streaks.

3. The image processing apparatus according to claim 1, wherein each of the degrees is a value obtained by averaging pixel values in one of the plurality of areas in a one-dimensional direction, performing Fourier transform on an average value obtained by the averaging, and integrating a frequency spectrum obtained by the Fourier transform.

4. The image processing apparatus according to claim 3, wherein each of the degrees is a value obtained by multiplying the frequency spectrum by visual characteristics to achieve weighting and by integrating a product obtained by the multiplication.

5. The image processing apparatus according to claim 1, wherein the evaluation unit calculates evaluation values to evaluate the image quality based on the degrees and the tilts.

6. The image processing apparatus according to claim 5, wherein, in a case where the evaluation values in the areas whose tilt is less than or equal to the predetermined angle include a relatively small evaluation value indicating a relatively large tilt, the evaluation unit outputs a warning.

7. The image processing apparatus according to claim 1, wherein the evaluation unit evaluates the image quality from the degrees in the plurality of areas including areas whose tilt is less than or equal to a predetermined angle.

8. The image processing apparatus according to claim 7, further comprising a frequency acquisition unit configured to acquire a frequency of each of the streaks, wherein the lower the frequency is, the more the evaluation unit increases the predetermined angle, when evaluating the image quality.

9. The image processing apparatus according to claim 8, wherein the frequency is calculated from an assumed viewing distance used for evaluating the print product.

10. The image processing apparatus according to claim 8, wherein the frequency is calculated from a viewing angle used for evaluating the print product.

11. An image processing method comprising:
acquiring a plurality of image data read from a plurality of areas of a print product; and
obtaining degrees of streaks in the plurality of areas and tilts in the plurality of areas using the plurality of image data and evaluating image quality of the print product based on the degrees and the tilts.

12. Anon-transitory computer-readable storage medium storing instructions that, when executed by a computer, cause the computer to perform a method comprising:
acquiring a plurality of image data read from a plurality of areas of a print product; and
obtaining degrees of streaks in the plurality of areas and tilts in the plurality of areas using the plurality of image data and evaluating image quality of the print product based on the degrees and the tilts.
